(19) United States
(12) Patent Application Publication
(10) Pub. No.: US 2015/0131016 A1
(43) Pub. Date: May 14, 2015

(54) BACK LIGHT DEVICE AND LIQUID CRYSTAL DISPLAY DEVICE INCLUDING THE SAME

(71) Applicant: Samsung Display Co., Ltd., Yongin-City (KR)

(72) Inventors: Seung-Wan KIM, Asan-Si (KR); Dae-Sik LEE, Asan-Si (KR); Jin-Won JANG, Asan-si (KR)

(73) Assignee: SAMSUNG DISPLAY CO., LTD., Yongin-City (KR)

(21) Appl. No.: 14/252,515

(22) Filed: Apr. 14, 2014

(30) Foreign Application Priority Data
Nov. 14, 2013 (KR) 10-2013-0138296

(51) Int. Cl. H05B 33/08; G02F 1/1335

(52) U.S. Cl. CPC H05B 33/0815; G02F 1/133603; G02F 2001/133612
USPC 349/42; 315/210

(57) ABSTRACT

A backlight device includes an input line connected to an anode of a light source unit; an output line connected to a cathode of the light source unit; a resistance line connected between the output line and a ground and disposed in a pattern having a predetermined width and length to have a predetermined resistance; a sensing line connected to the output line; and a controller for measuring a balance voltage of the output line through the sensing line and controls an amount of current supplied to the input line based on the balance voltage, in which when a reference current is supplied to the input line, the balance voltage of the output line becomes a predetermined reference voltage due to the predetermined resistance.

### CROSS-REFERENCE TO RELATED APPLICATION

This application claims priority from Korean Patent Application No. 10-2013-0138296 filed in the Korean Intellectual Property Office on Nov. 14, 2013, and all the benefits accruing therefrom, the contents of which are herein incorporated by reference in their entirety.

### BACKGROUND

(a) Technical Field

Embodiments of the present disclosure are directed to a backlight device and a liquid crystal display device including the same, and more particularly, to a backlight device that can provide a uniform current and a liquid crystal display device including the same.

(b) Discussion of the Related Art

A liquid crystal display device is a passive device which does not emit light by itself and includes a liquid crystal display panel which displays an image and a backlight device which supplies light to the liquid crystal display panel. The backlight device includes a light source which emits light. Light sources for a backlight device have included a cold cathode fluorescent lamp (CCFL), an external electrode fluorescent lamp (EEFL), etc. More recently, light emitting diodes (LEDs) have been used instead.

Unlike a cold cathode fluorescent lamp, light emitting diodes (LED) do not include mercury and are therefore more environmentally-friendly. In addition, LEDs have a color reproducibility of 104% compared with the national television system committee (NTSC) standard, and can represent colors which are closer to nature.

A backlight device that uses a light emitting diode (LED) includes a plurality of light emitting diodes (LEDs) which are uniformly distributed. The plurality of light emitting diodes (LEDs) should emit a uniform light. To this end, a uniform current needs to be supplied to the plurality of light emitting diodes (LEDs). A backlight device typically includes a plurality of resistor elements to supply a uniform current to the plurality of light emitting diodes (LEDs).

As a size of a display device increases, the backlight device needs to include a larger number of resistor elements, for which an area of a printed circuit board (PCB) therefor may be increased and manufacturing cost of the display device may be increased.

### SUMMARY

Embodiments of the present disclosure may provide a backlight device capable of providing a uniform current without using a resistor element, and a liquid crystal display device including the same.

An exemplary embodiment of the present disclosure provides a backlight device, including: an input line connected to an anode of a light source unit; an output line connected to a cathode of the light source unit; a resistance line connected between the output line and a ground and disposed in a pattern having a predetermined width and length to have a predetermined resistance; a sensing line connected to the output line; and a controller for measuring a balance voltage of the output line through the sensing line and controls an amount of current supplied to the input line based on the balance voltage, in which when a reference current is supplied to the input line, the balance voltage of the output line becomes a predetermined reference voltage due to the predetermined resistance.

The backlight device may further include: a light emitting control transistor that includes a gate electrode connected to the controller, a first electrode connected to the output line, and a second electrode connected to the resistance line. The controller, the sensing line, the light emitting control transistor and the ground may be disposed on a control substrate

The resistance line may connect the second electrode of the light emitting control transistor to the ground.

The resistance line may connect a cable connected to the control substrate to the ground and has pattern that reciprocates the cable.

One end of the cable may be connected to the control substrate and the other end of the cable may be connected to a connection substrate connected to a light source assembly that includes the light source unit and the resistance line may be connected from the second electrode of the light emitting control transistor to the connection substrate through the cable, may be connected back to the control substrate through the cable by returning from the connection substrate, and is connected to the ground

The controller and the sensing line may be disposed on a control substrate, the light source unit, the ground, and the output line may be disposed on a light source substrate connected to the control substrate, and the resistance line may connect the output line to the ground.

The controller, the ground, and the sensing line may be disposed on a control substrate, the light source unit and the output line may be disposed on a light source substrate connected to the control substrate, and the resistance line may connect the output line to the ground through a cable connecting the control substrate to the light source substrate.

The sensing line may connected the output line of the light source substrate to the controller of the control substrate through the cable.

The backlight device may further include: an inductor that includes one end to which an input voltage is supplied and a second end connected to the input line; and a switching transistor that includes a gate electrode connected to the controller, a first electrode connected to the input line, and a second electrode connected to the ground.

The controller may decrease an duty cycle of the switching transistor when the balance voltage is less than the reference voltage and increase the duty cycle of the switching transistor when the balance voltage is greater than the reference voltage to control an amount of current supplied to the input line.

The backlight device may further include: a panel unit that includes a thin film transistor panel, a color filter panel, and a liquid crystal layer interposed therebetween, wherein the backlight device is coupled to one side of the panel unit

Another exemplary embodiment of the present invention provides a liquid crystal display device, including: a light source unit; an input line connected to an anode of the light source unit; an output line connected to a cathode of the light source unit; a resistance line connected between the output line and a ground and disposed in a pattern having a predetermined width and length to have a predetermined resistance; and a sensing line connected to the output line; in which the sensing line is disposed on a control substrate, the light source unit, the ground, and the output line are disposed on a light source substrate connected to the control substrate, the resistance line connects the output line to the ground. When a reference current is supplied to the input line, a balance voltage of the output line becomes a predetermined reference voltage due to the predetermined resistance.

The backlight device may further include a controller disposed on the control substrate configured to measure the balance voltage of the output line through the sensing line and to control an amount of current supplied to the input line based on the balance voltage; and a switching transistor that includes a gate electrode connected to the controller, a first electrode connected to the input line, and a second electrode connected to the ground. The controller may decrease a duty cycle of the switching transistor when the balance voltage is less than the reference voltage and may increase the duty cycle of the switching transistor when the balance voltage is greater than the reference voltage to control an amount of current supplied to the input line.

The backlight device may further include a panel unit that includes a thin film transistor panel, a color filter panel, and a liquid crystal layer interposed therebetween. The backlight device may be coupled to one side of the panel unit.

Another exemplary embodiment of the present invention provides a liquid crystal display device, including: a light source unit; an input line connected to an anode of the light source unit; an output line connected to a cathode of the light source unit; a resistance line connected between the output line and a ground and disposed in a pattern having a predetermined width and length to have a predetermined resistance; and a sensing line connected to the output line; in which the ground, and the sensing line are disposed on a control substrate, the light source unit and the output line are disposed on a light source substrate connected to the control substrate, and the resistance line connects the output line to the ground through a cable connecting the control substrate to the light source substrate. When a reference current is supplied to the input line, a balance voltage of the output line becomes a predetermined reference voltage due to the predetermined resistance.

The sensing line may connect the output line of the light source substrate to the controller of the control substrate through the cable.

The backlight device may further include a controller disposed on the control substrate configured to measure the balance voltage of the output line through the sensing line and to control an amount of current supplied to the input line based on the balance voltage; and a switching transistor that includes a gate electrode connected to the controller, a first electrode connected to the input line, and a second electrode connected to the ground. The controller may decrease a duty cycle of the switching transistor when the balance voltage is less than the reference voltage and may increase the duty cycle of the switching transistor when the balance voltage is greater than the reference voltage to control an amount of current supplied to the input line.

The backlight device may further include a panel unit that includes a thin film transistor panel, a color filter panel, and a liquid crystal layer interposed therebetween. The backlight device may be coupled to one side of the panel unit.

According to the exemplary embodiments of the present disclosure, the backlight device may provide a uniform current without using a resistor element.

According to the exemplary embodiments of the present disclosure, the area of the printed circuit board (PCB) of the backlight device and the manufacturing cost of the display device may be reduced by not using a resistor element.

### BRIEF DESCRIPTION OF THE DRAWINGS

FIG. 1 is an exploded perspective view of a liquid crystal display device that includes a backlight device according to an exemplary embodiment of the present disclosure.

FIG. 2 is an exploded perspective view of a backlight device according to an exemplary embodiment of the present disclosure.

FIG. 3 is a coupled perspective view of a backlight device according to an exemplary embodiment of the present disclosure.

FIG. 4 is a circuit diagram illustrating a converter circuit of a backlight device according to an exemplary embodiment of the present disclosure.

FIG. 5 is a perspective view of a control substrate according to an exemplary embodiment of the present disclosure that provides a uniform current without using a resistor element in the backlight device.

FIG. 6 is a perspective view of a control substrate according to another exemplary embodiment of the present disclosure that provides a uniform current without using a resistor element in the backlight device, and a cable connected thereto.

FIG. 7 is a perspective view of a connection substrate connected to the cable of FIG. 6.

FIG. 8 is a circuit diagram of a converter circuit of a backlight device according to another exemplary embodiment of the present disclosure.

FIG. 9 is a perspective view of a light source assembly according to another exemplary embodiment of the present disclosure that provides a constant current without using a resistor element in the backlight device.

FIG. 10 is a perspective view of a light source assembly according to another exemplary embodiment of the present disclosure that provides a constant current without using a resistor element in the backlight device.

FIG. 11 is a perspective view of a cable connected to the light source assembly of FIG. 10.

FIG. 12 is a perspective view of a control substrate connected to the cable of FIG. 11.

### DETAILED DESCRIPTION

In the following detailed description, only certain exemplary embodiments of the present disclosure have been shown and described, simply by way of illustration. As those skilled in the art would realize, the described embodiments may be modified in various different ways, all without departing from the spirit or scope of the present disclosure.

Further, in exemplary embodiments, since like reference numerals may designate like elements having a similar configuration, a first exemplary embodiment is representatively described, and in other exemplary embodiments, only a configuration different from the first exemplary embodiment will be described.

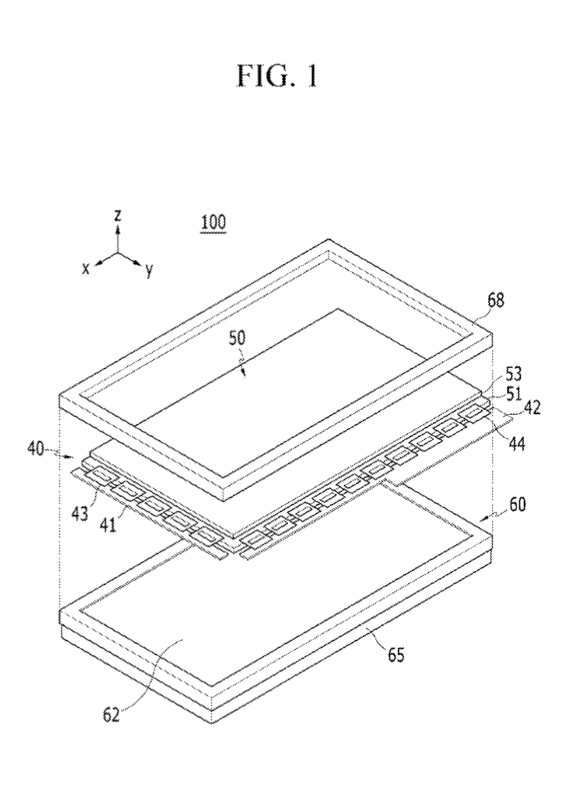

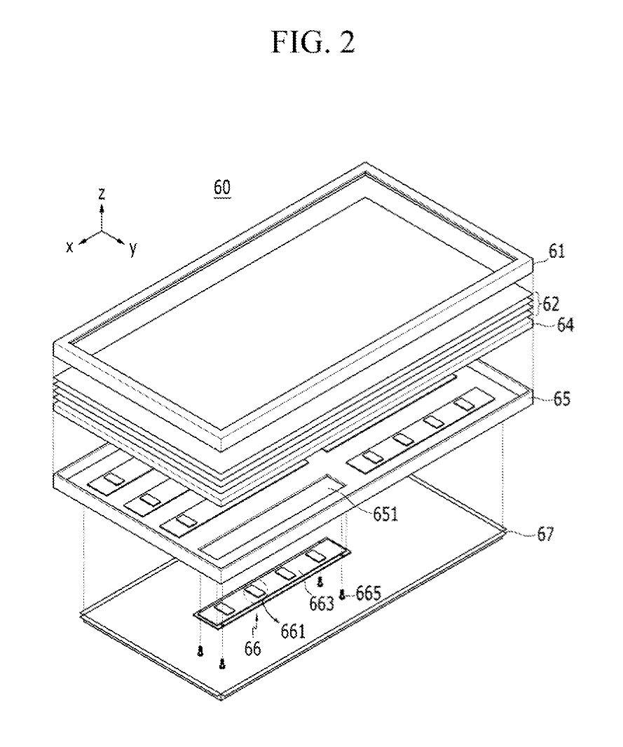

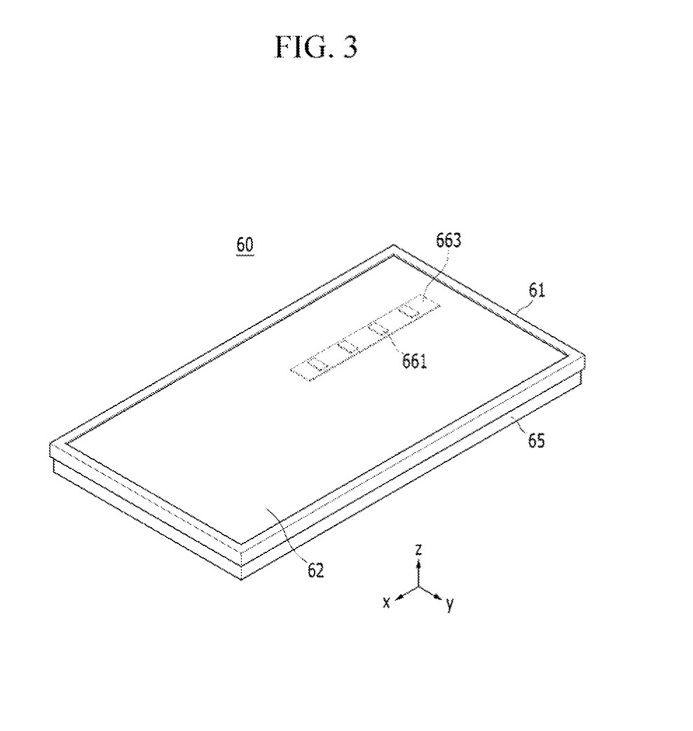

FIG. 1 is an exploded perspective view of a liquid crystal display device that includes a backlight device according to an exemplary embodiment of the present disclosure. FIG. 2 is an exploded perspective view of a backlight device according to an exemplary embodiment of the present disclosure. FIG. 3 is a coupled perspective view of a backlight device according to an exemplary embodiment of the present disclosure.

Referring to FIGS. 1 to 3, a display device 100 includes a panel unit assembly 40 and a backlight device 60.

The panel unit assembly 40 includes a panel unit 50, driver integrated circuit packages (driver IC packages) 43 and 44, and printed circuit boards 41 and 42. As the driver IC package, a chip on film (COF), a tape carrier package, etc., may be used.

As the panel unit 50, a liquid crystal display panel may be used. This is only an example of the present disclosure, and embodiments of the present disclosure are not limited thereto.

The panel unit 50 includes a TFT panel 51 configured from a plurality of thin film transistors (TFTs), a color filter 53 disposed on the TFT panel 51, and a liquid crystal layer injected between these panels. A polarizer is attached to an upper portion of the color filter panel 53 and a lower portion of the TFT panel 51 to polarize light transmitted to the panel unit 50.

The TFT panel 51 is a transparent glass substrate upon which thin film transistors are disposed in a matrix form. Source terminals of the thin film transistors are connected to data lines and gate terminals thereof are connected to gate lines. Further, drain terminals of the thin film transistors are connected to pixel electrodes made of a conductive and transparent material such as indium tin oxide (ITO).

When electrical signals are transmitted from the printed circuit boards (PCBs) 41 and 42 to each of the gate lines and data lines of the panel unit 50, the electrical signals are transmitted to the gate terminals and the source terminals of the TFTs. Due to the receipt of the electrical signals, the TFT may be turned on or off, so that the electrical signal required for pixel emission is output to the drain terminal.

In addition, the color filter panel 53 is disposed on the TFT panel 51 opposite from the TFT panel 51. The color filter panel 53 includes a plurality of RGB pixels representing predetermined colors, and is formed by a thin film process after which a front surface thereof is applied with a common electrode made of ITO. When the thin film transistor is turned on by supplying power to the gate terminal and the source terminal of the TFT, an electric field is generated between the pixel electrode and the common electrode of the color filter panel 53. An orientation angle of a liquid crystal layer between the TFT panel 51 and the color filter panel 53 is changed by the electric field, and light transmittance changes depending on the changed orientation angle, thereby causing a pixel to emit light with the desired color and intensity.

The printed circuit boards (PCBs) 41 and 42 receive image signals from outside of the panel unit 50 to apply driving signals to the gate lines and data lines connected to the driving IC packages 43 and 44 attached to the panel unit 50. To drive the display device 100, the gate printed circuit board (PCB) 41 transmits a gate driving signal and the data printed circuit board (PCB) 42 transmits a data driving signal. That is, the gate driving signal and the data driving signal are supplied to the gate line and the data line of the panel unit 50 through each of the driving IC packages 43 and 44.

The backlight device 60 may be a direct type backlight device such as those used in large display devices, such as an LCD TV. A structure of the backlight device 60 illustrated in FIG. 1 is only an example of the present disclosure, and embodiments of the present disclosure are not limited thereto. Therefore, embodiments of the present disclosure may use backlight devices having other structures.

The backlight device 60 includes a plurality of optical sheets 62, a diffusion member 64, and a plurality of light source assemblies 66. Further, the backlight device 60 includes a first top chassis 61, a mold frame 65 and a bottom chassis 67 to fix the above components.

The light source assembly 66 includes light source units 661 which emit light and a light source substrate 663 upon which the light source units 661 are mounted and which drives the light source units 661. The light source units 661 may include light emitting diodes (LED).

The plurality of light source assemblies 66 are received in the mold frame 65 and may be arranged in an X-axis direction. In addition, a plurality of wirings are mounted on a rear surface of the mold frame 65 to connect the plurality of light source assemblies 66 to each other. A lower portion of the bottom chassis 67 is provided with a converter connected to wiring from the light source assembly 66. The converter receives external power and converts it to a driving voltage that is supplied to the light source assembly 66.

The light source assembly 66 is fixed to an opening 651 formed in the mold frame 65. The light source assembly 66 may be firmly fixed to the mold frame 65 using a screw 665. Alternatively, the light source assembly 66 may also be fixed to the mold frame 65 by using an adhesive, etc. After the light source assembly 66 is fixed, the light source assembly 66 may be covered with the bottom chassis 67. The bottom chassis 67 may be fixed outside the mold frame 65 to protect the light source assembly 66 from an external impact. In some cases, the bottom chassis 67 may not be used.

Herein, a structure of the backlight device 60 in which the plurality of light source assemblies 66 are fixed by the mold frame 65 is described as an example, but embodiments of the present disclosure are not limited thereto.

The panel unit 50 may be stably fixed on the backlight device 60 using a second top chassis 68, and the printed circuit boards (PCBs) 41 and 42 may be received along a side of the second top chassis 68. That is, one side of the panel unit 50 is coupled with the backlight device 60.

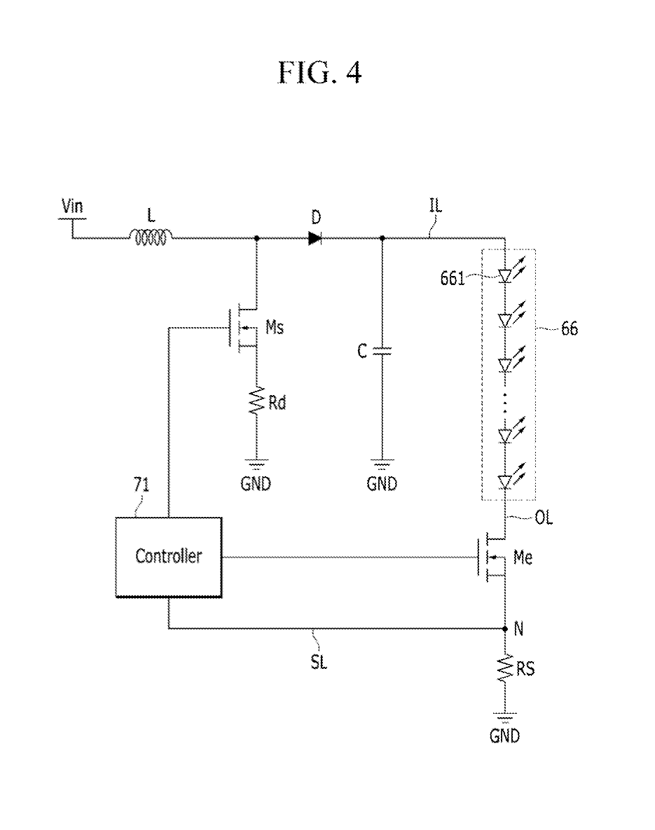

FIG. 4 is a circuit diagram that illustrates a converter circuit of a backlight device according to an exemplary embodiment of the present disclosure.

Referring to FIG. 4, the converter circuit includes an inductor L, a diode D, a capacitor C, a switching transistor Ms, a light emitting control transistor Me, a driving resistor Rd, a resistance line Rs, and a controller 71.

One end of the inductor L is connected to an input voltage Vin and the other end is connected to an anode of the diode D.

The diode D includes an anode connected to the other end of the inductor L and a cathode connected to the light source assembly 66.

The light source assembly 66 may include the plurality of light source units 661 connected in series. An input line IL may be connected to an anode of a first light source unit 661 and the diode D may be connected to the anode of the light source unit 661 through the input line IL. An output line OL is connected to the cathode of the final light source unit 661.

The capacitor C includes one electrode connected to the input line IL and the other electrode connected to a ground GND. The capacitor C stabilizes a voltage of the input line IL.

The switching transistor Ms includes a gate electrode connected to the controller 71, one electrode connected to the other end of the inductor L, and a second electrode connected to ground GND. The one electrode of the switching transistor Ms is connected to the input line IL through the diode D. The driving resistor Rd is positioned between the switching transistor Ms and ground GND.

The light emitting control transistor Me includes a gate electrode connected to the controller 71, one electrode connected to the output line OL, and a second electrode connected to a sensing node N.

One end of the resistance line Rs is connected to the sensing node N and the other end is connected to ground GND. That is, the resistance line Rs is connected between the output line OL and ground GND. The resistance line Rs may have a predetermined width and length so that a balance voltage of the output line OL becomes a predetermined reference voltage when a reference current is supplied to the input line IL.

One end of a sensing line SL is connected to the sensing node N and the other end of the sensing line SL is connected to the controller 71. That is, the controller 71 and the sensing node N are connected to the sensing line SL.

The controller 71 measures the balance voltage of the output line OL using the sensing line SL and controls the amount of current supplied to the input line IL based on the balance voltage. The controller 71 controls a duty cycle of the switching transistor Ms to control the amount of current supplied to the input line IL. The duty cycle refers to the time during which the switching transistor Ms is turned on.

The controller 71 decreases the duty cycle of the switching transistor Ms when the balance voltage is less than the reference voltage. As the duty cycle of the switching transistor Ms decreases, the amount of current flowing from the input voltage Vin to ground GND decreases and the amount of current flowing in the input line IL increases, thereby increasing the voltage of the input line IL. As the voltage of the input line IL increases, the balance voltage also increases.

The controller 71 increases the duty cycle of the switching transistor Ms when the balance voltage is greater than the reference voltage. As the duty cycle of the switching transistor Ms increases, the amount of current flowing from the input voltage Vin to ground GND increases and the amount of current flowing in the input line IL decreases, thereby decreasing the voltage of the input line IL. As the voltage of the input line IL decreases, the balance voltage also decreases.

By this method, the controller 71 controls the duty cycle of the switching transistor Ms to make the amount of current supplied to the input line IL more uniform. That is, the controller 71 may supply a substantially uniform current to the light source assembly 66.

In addition, the controller 71 can turn the light emitting control transistor Me on or off to control the emission of the light source assembly 66. When the light emitting control transistor Me is turned on, a current flows in the light source assembly 66, so that the plurality of light source units 661 may emit light. On the other hand, when the light emitting control transistor Me is turned off, no current flows in the light source assembly 66, such that the plurality of light source units 661 do not emit light.

Herein, one light source assembly 66 is illustrated, but there may be a plurality of light source assemblies 66 in other embodiments. In this case, the plurality of light source assemblies 66 may be connected in parallel and each light source assembly 66 may be connected to the light emitting control transistor Me. The controller 71 may selectively turn on or off any one of the light emitting control transistors Me connected to each of the plurality of light source assemblies 66, so that the plurality of light source assemblies 66 may selectively emit light.

Hereinafter, a detailed exemplary embodiment of the present disclosure in which the resistance line Rs of the converter is formed will be described.

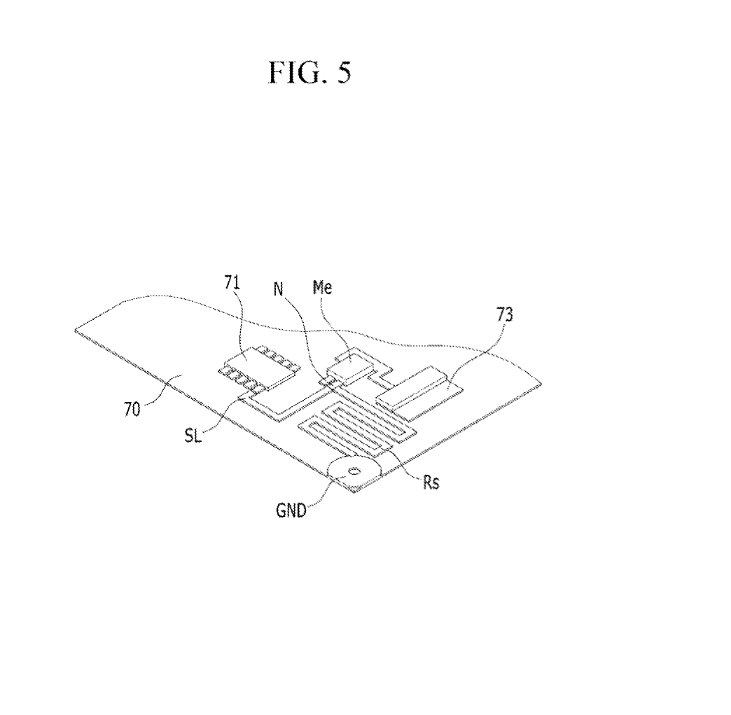

FIG. 5 is a perspective view that illustrates a control substrate according to an exemplary embodiment of the present disclosure that provides a uniform current without using a resistor element in the backlight device.

Referring to FIG. 5, the controller 71, the sensing line SL, the light emitting control transistor Me, the ground GND, the resistance line Rs, and a connection part 73 are disposed on a control substrate 70.

The control substrate 70 may be a printed circuit board (PCB). The controller 71 may be an integrated circuit (IC) chip which controls the overall driving of the converter.

The connection part 73 may be connected to a cable and connects the light source assembly 66 to the control substrate 70. The cable may be a flexible film cable (FFC). In this case, the connection part 73 may be a standardized connector to which the cable may be connected.

One electrode of the light emitting control transistor Me is connected to the output line OL through the connection part 73. The second electrode of the light emitting control transistor Me is connected to the sensing node N. The sensing node N is connected to the sensing line SL and the resistance line Rs.

The sensing line S connects the sensing node N to the controller 71.

The resistance line Rs connects the ground GND and the sensing node N to each other. In this case, the resistance line Rs has a predetermined width and length, and thus the resistance line Rs may have a predetermined resistance. Therefore, when the reference current is supplied to the input line IL, the balance voltage of the output line OL becomes equal to a predetermined reference voltage.

The resistance line Rs has a predetermined pattern on the control substrate 70 so that the resistance line Rs may have the predetermined resistance. As illustrated, the resistance line Rs may have a zigzag pattern between the sensing node N and the ground GND. A width and length of the zigzag pattern are determined so that the resistance line Rs may have the desired resistance.

For example, if the resistance line Rs is made of copper having a resistance coefficient of 0.0000172 Ωmm, the width of the resistance line Rs may be designed to be 0.15 mm and the length thereof may be designed to be 300 mm. A copper wiring on the substrate may have a thickness of approximately 0.035 mm. In this case, the resistance of the resistance line Rs becomes approximately 0.9829Ω.

As such, the width and length of the resistance line Rs are appropriately determined, and thus the resistance line Rs may have a resistance of approximately 1Ω. In this case, a space occupied by the resistance line Rs on the control substrate 70 is very small. Therefore, the resistance line Rs may be formed using an empty space on the control substrate 70. That is, there is no need to use a separate resistor element to provide a uniform current in a backlight device.

Herein, a zigzag pattern resistance line Rs is illustrated as an example, but embodiments of the present disclosure are not limited thereto, and therefore the resistance line Rs may have any pattern having a width and a length which can yield the desired resistance.

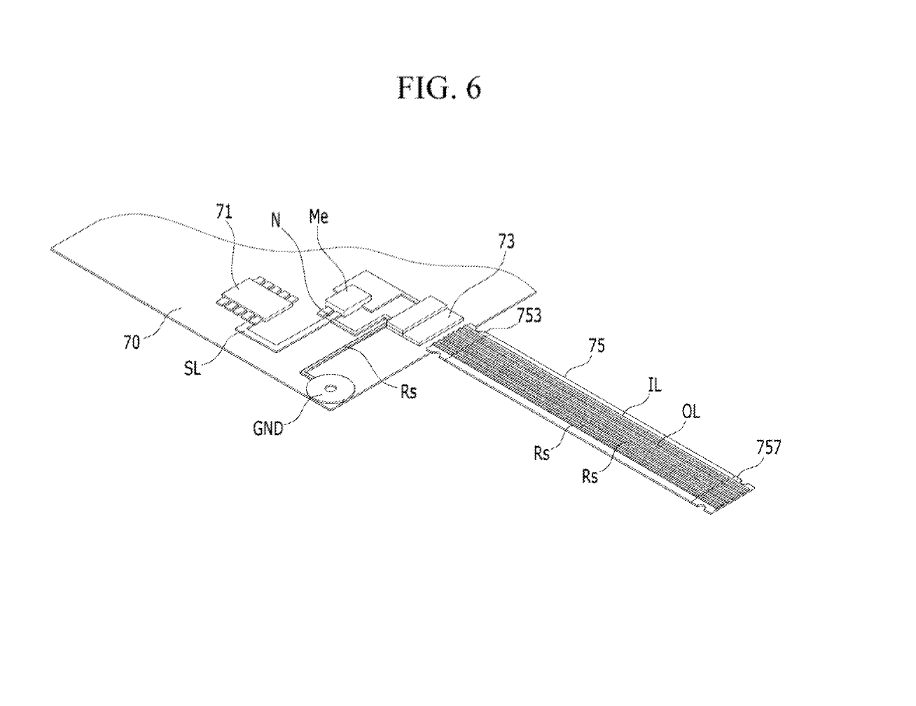

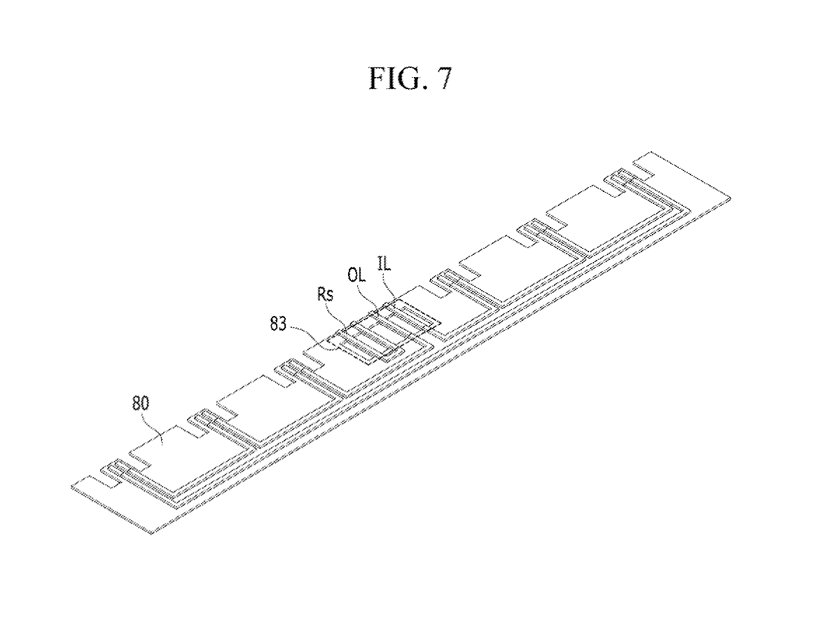

FIG. 6 is a perspective view of a control substrate according to another exemplary embodiment of the present disclosure that provides a uniform current without using a resistor element in the backlight device, and a cable connected thereto. FIG. 7 is a perspective view of a connection substrate connected to the cable of FIG. 6.

Referring to FIGS. 6 and 7, similar to FIG. 5, the controller 71, the sensing line SL, the light emitting control transistor Me, the ground GND, the resistance line Rs, and the connection part 73 are disposed on the control substrate 70.

However, the resistance line Rs is formed in a pattern which reciprocates a cable 75 connected to the control substrate 70 and the ground GND on the control substrate 70.

The cable 75 may be a flexible film cable (FFC). In this case, the connection part 73 may be a standardized connector to which the cable 75 may be connected. The cable 75 includes a plurality of wiring lines. One of the plurality of wiring lines may be the input line IL connected to the light source unit 661 and another wiring line is the output line OL connected to the light source unit 661. The remaining wiring lines may be dummy lines. A first end 753 of the cable 75 is connected to the control substrate 70 through the connection part 73 and a second end 757 thereof is connected to a connection substrate 80.

The connection substrate 80 is connected to at least one light source assembly 66. The connection substrate 80 may have another connection part 83 that connects to the cable 75. The cable 75 is connected to the connection substrate 80 through the connection part 83 and at least one light source assembly 66 is connected to the input line IL and the output line OL through the connection substrate 80.

The pattern of resistance line Rs may reciprocate the cable 75 using two dummy lines of the cable 75. The resistance line Rs connects to the cable 75 from the second electrode of the light emitting control transistor Me through the connection part 73, connects to the connection substrate 80 through the cable 75, and connects back to the control substrate 70 through the cable 75 and the connection part 73 from the connection substrate 80, and connects to the ground on the control substrate 70.

For example, if a flexible film cable (FFC) of 1 m and resistance coefficient of approximately 0.63 Ω/m is used, the resistance of the resistance line Rs becomes approximately 1.26Ω.

As such, the dummy wiring of the cable 75, which connects the control substrate 70 to the connection substrate 80, is used as the resistance line Rs, such that the backlight device has the the resistance for providing a uniform current, and there is no need to use a separate resistor element.

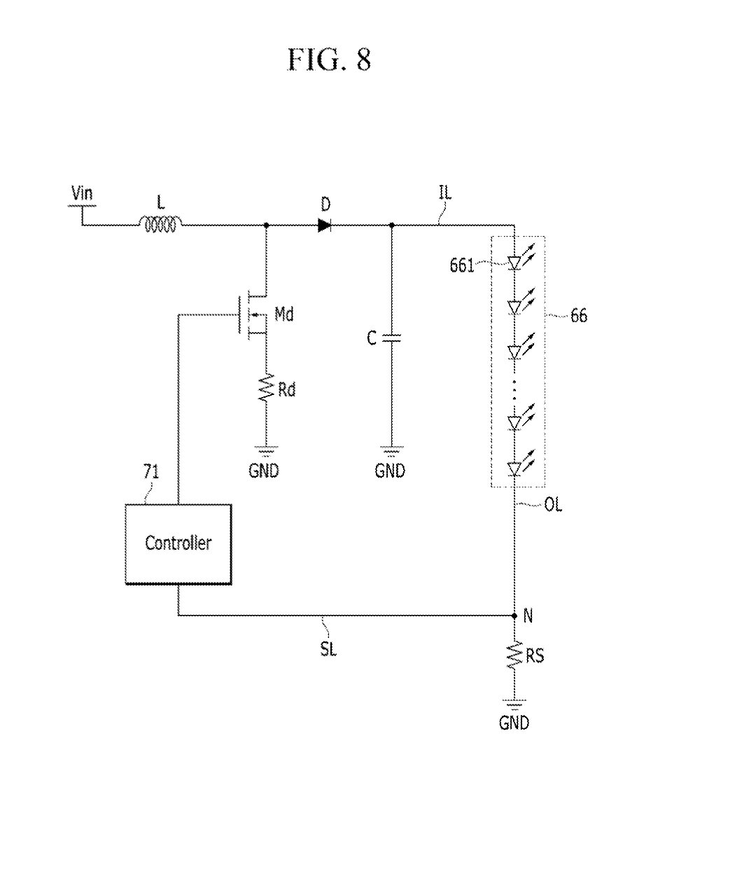

FIG. 8 is a circuit diagram of a converter circuit of a backlight device according to another exemplary embodiment of the present disclosure.

The difference with respect to FIG. 4 is that the light emitting control transistor Me is omitted. Thus, when a plurality of light source assemblies 66 are provided in the backlight device, the plurality of light source assemblies 66 simultaneously emit light or stop emitting light.

Other components are the same as those of FIG. 4, and therefore the detailed description thereof will be omitted.

Hereinafter, an exemplary embodiment of the present disclosure will be described in which the resistance line Rs is formed, but the converter circuit does not include a light emitting control transistor Me.

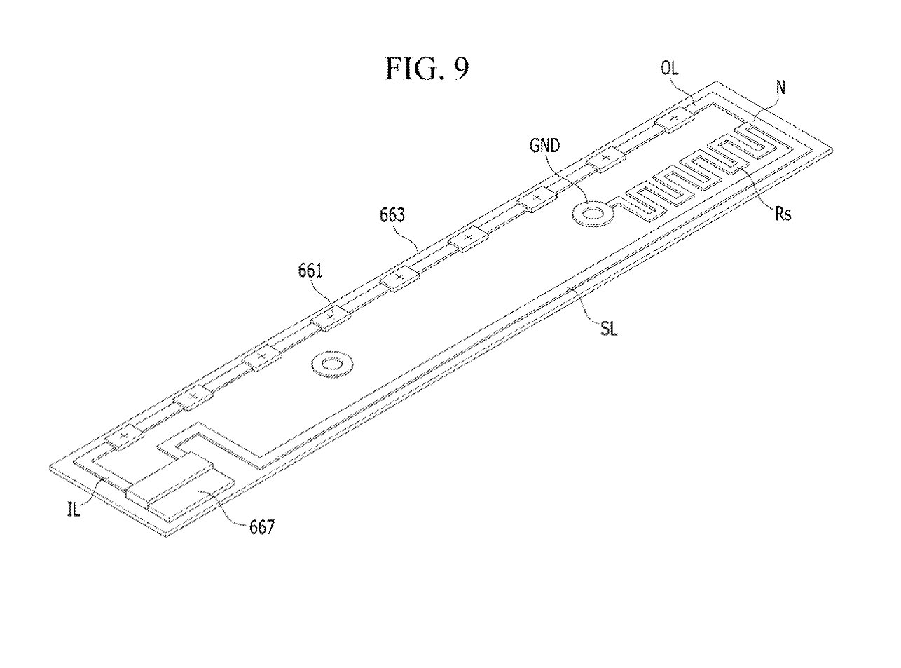

FIG. 9 is a perspective view of a light source assembly according to another exemplary embodiment of the present disclosure that provides a uniform current without using a resistor element in the backlight device.

Referring to FIG. 9, the light source assembly 66 includes the plurality of light source units 661 disposed on a light source substrate 663

The light source substrate 663 may be a printed circuit board (PCB). The plurality of light source lines 661 are connected in series on the light source substrate 663. The light source substrate 663 may have a connection part 667 to be connected to the cable 75 or the connection substrate 80. The light source substrate 663 may be connected to the control substrate 70 through the cable 75 or the connection substrate 80 which is connected to the connection part 667.

The input line IL, the output line OL, the sensing line SL, the ground GND, the sensing node N, and the resistance line Rs are disposed on the light source substrate 663. The input line IL connects connection part 667 to the first light source unit 661. The output line OL connects the final light source unit 661 to the sensing node N. The sensing line SL connects the sensing node N to the connection part 667.

The resistance line Rs connects the output line OL to the sensing node N to the ground GND on the light source substrate 663. In this case, a pattern of the resistance line Rs has a predetermined width and length so that the resistance line Rs may have a predetermined resistance. As illustrated, the resistance line Rs may have a zigzag pattern in a space between the sensing node N and ground GND. The width and length of the zigzag pattern may be appropriately determined so that the resistance line Rs may have the desired resistance.

Herein, a zigzag pattern resistance line Rs on the light source substrate 663 is illustrated as an example, but embodiments of the present disclosure are not limited thereto, and therefore the resistance line Rs may have any pattern on the light source substrate 663, as long as the width and length are appropriate for the desired resistance.

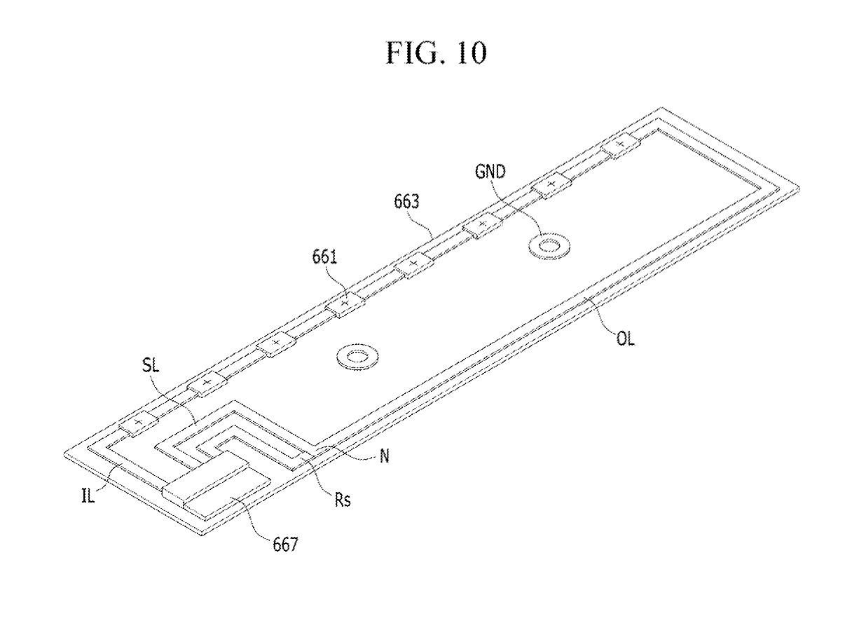

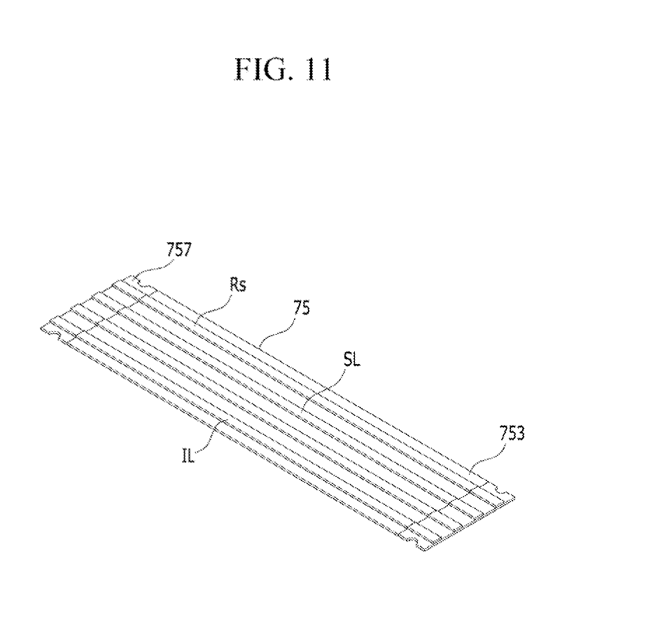

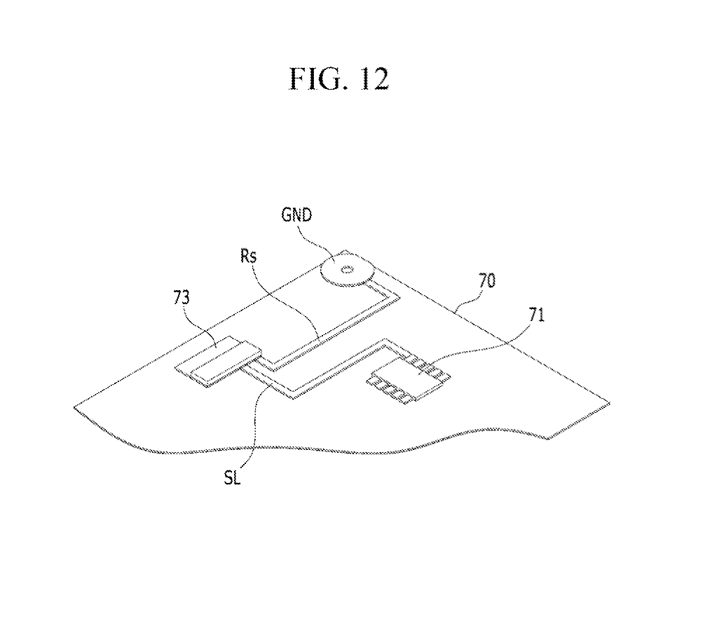

FIG. 10 is a perspective view of a light source assembly according to another exemplary embodiment of the present disclosure that provides a uniform current without using a resistor element in the backlight device. FIG. 11 is a perspective view of a cable connected to the light source assembly of FIG. 10. FIG. 12 is a perspective view of a control substrate connected to the cable of FIG. 11.

Referring to FIGS. 10 to 12, the plurality of light source units 661, the input line IL, the output line OL, the sensing line SL, the resistance line Rs, and the connection part 667 are disposed on the light source substrate 663. The connection part 667 of the light source substrate 663 is connected to the second end 757 of the cable 75.

The cable 75 is provided with the input line IL, the sensing line SL, and the resistance line Rs. The second end 757 of the cable 75 is connected to the connection part 667, so that the input line IL, the sensing line SL, and the resistance line Rs of the cable 75 may be each connected to the input line IL, the sensing line SL, and the resistance line Rs of the light source substrate 663.

The first end 753 of the cable 75 is connected to the connection part 73 of the control substrate 70.

The controller 71, the sensing line SL, the ground GND, the resistance line Rs, and the connection part 73 are disposed on the control substrate 70. The resistance line Rs of the control substrate 70 is connected to the ground GND on the control substrate 70. The sensing line SL of the control substrate 70 is connected to the controller 71. The first end 753 of the cable 75 is connected to the connection part 73 of the control substrate 70, so that the sensing line SL and the resistance line Rs of the cable 75 may be each connected to the sensing line SL and the resistance line Rs of the control substrate 70. Herein, the input line IL is omitted from the control substrate 70.

That is, the resistance line Rs connects from the output line OL connected to the sensing node N to the ground GND on the control substrate 70 through the cable 75. Further, the sensing line SL connects from the output line OL connected to the sensing node N of the light source substrate 663 to the controller 71 of the control substrate 70 through the cable 75.

The resistance line Rs has a predetermined resistance that depends on the predetermined width and the length of resistance line Rs from the output line OL on the light source substrate 663 to the ground GND on the control substrate 70.

As such, the resistance line Rs is formed using the cable 75 that connects the light source substrate 663 to the control substrate 70, to create a resistor that provides a uniform current in a backlight device, and there is no need to use a separate resistor element.

The accompanying drawings and the detailed description of the exemplary embodiments of the present disclosure are illustrated by way of example and are not used to limit the meaning or limit the scope of the present disclosure described in the appended claims but are used to describe the present disclosure. Therefore, it will be appreciated by those skilled in the art that various modifications can be made and other equivalent embodiments are available. Therefore, a true technical scope of embodiments of the present disclosure will be defined by the technical spirit of the appended claims.

What is claimed is:

1. A backlight device, comprising:
an input line connected to an anode of a light source unit;
an output line connected to a cathode of the light source unit;
a resistance line connected between the output line and a ground and disposed in a pattern having a predetermined width and length to have a predetermined resistance;
a sensing line connected to the output line; and
a controller configured to measure a balance voltage of the output line through the sensing line and to control an amount of current supplied to the input line based on the balance voltage,
wherein when a reference current is supplied to the input line, the balance voltage of the output line becomes a predetermined reference voltage due to the predetermined resistance.

2. The backlight device of claim 1, further comprising:
a light emitting control transistor that includes a gate electrode connected to the controller, a first electrode connected to the output line, and a second electrode connected to the resistance line, wherein:
the controller, the sensing line, the light emitting control transistor and the ground are disposed on a control substrate.

3. The backlight device of claim 2, wherein:
the resistance line connects the second electrode of the light emitting control transistor to the ground.

4. The backlight device of claim 2, wherein:
the resistance line connects a cable connected to the control substrate to the ground and has pattern that reciprocates the cable.

5. The backlight device of claim 4, wherein:
one end of the cable is connected to the control substrate and the other end of the cable is connected to a connection substrate connected to a light source assembly that includes the light source unit, and
the resistance line is connected from the second electrode of the light emitting control transistor to the connection substrate through the cable, is connected back to the control substrate through the cable by returning from the connection substrate, and is connected to the ground.

6. The backlight device of claim 1, wherein:
the controller and the sensing line are disposed on a control substrate,
the light source unit, the ground, and the output line are disposed on a light source substrate connected to the control substrate, and
the resistance line connects the output line to the ground.

7. The backlight device of claim 1, wherein:
the controller, the ground, and the sensing line are disposed on a control substrate,
the light source unit and the output line are disposed on a light source substrate connected to the control substrate, and
the resistance line connects the output line to the ground through a cable connecting the control substrate to the light source substrate.

8. The backlight device of claim 7, wherein:
the sensing line connects the output line of the light source substrate to the controller of the control substrate through the cable.

9. The backlight device of claim 1, further comprising:
an inductor that includes one end to which an input voltage is supplied and a second end connected to the input line; and
a switching transistor that includes a gate electrode connected to the controller, a first electrode connected to the input line, and a second electrode connected to the ground.

10. The backlight device of claim 9, wherein:
the controller decreases a duty cycle of the switching transistor when the balance voltage is less than the reference voltage and increases the duty cycle of the switching transistor when the balance voltage is greater than the reference voltage to control an amount of current supplied to the input line.

11. The backlight device of claim 1, further comprising:
a panel unit that includes a thin film transistor panel, a color filter panel, and a liquid crystal layer interposed therebetween, wherein the backlight device is coupled to one side of the panel unit.

12. A backlight device, comprising:
a light source unit;
an input line connected to an anode of the light source unit;
an output line connected to a cathode of the light source unit;
a resistance line connected between the output line and a ground and disposed in a pattern having a predetermined width and length to have a predetermined resistance; and
a sensing line connected to the output line;
wherein the sensing line is disposed on a control substrate,
the light source unit, the ground, and the output line are disposed on a light source substrate connected to the control substrate,
the resistance line connects the output line to the ground,
wherein when a reference current is supplied to the input line, a balance voltage of the output line becomes a predetermined reference voltage due to the predetermined resistance.

13. The backlight device of claim 12, further comprising:
a controller disposed on the control substrate configured to measure the balance voltage of the output line through the sensing line and to control an amount of current supplied to the input line based on the balance voltage; and
a switching transistor that includes a gate electrode connected to the controller, a first electrode connected to the input line, and a second electrode connected to the ground, wherein:
the controller decreases a duty cycle of the switching transistor when the balance voltage is less than the reference voltage and increases the duty cycle of the switching transistor when the balance voltage is greater than the reference voltage to control an amount of current supplied to the input line.

14. The backlight device of claim 12, further comprising:
a panel unit that includes a thin film transistor panel, a color filter panel, and a liquid crystal layer interposed therebetween,
wherein the backlight device is coupled to one side of the panel unit.

15. A backlight device, comprising:
a light source unit;
an input line connected to an anode of the light source unit;
an output line connected to a cathode of the light source unit;
a resistance line connected between the output line and a ground and disposed in a pattern having a predetermined width and length to have a predetermined resistance; and
a sensing line connected to the output line;
wherein the ground, and the sensing line are disposed on a control substrate,
the light source unit and the output line are disposed on a light source substrate connected to the control substrate, and
the resistance line connects the output line to the ground through a cable connecting the control substrate to the light source substrate,
wherein when a reference current is supplied to the input line, a balance voltage of the output line becomes a predetermined reference voltage due to the predetermined resistance.

16. The backlight device of claim 15, wherein:
the sensing line connects the output line of the light source substrate to the controller of the control substrate through the cable.

17. The backlight device of claim 15, further comprising:
a controller disposed on the control substrate configured to measure the balance voltage of the output line through the sensing line and to control an amount of current supplied to the input line based on the balance voltage; and
a switching transistor that includes a gate electrode connected to the controller, a first electrode connected to the input line, and a second electrode connected to the ground, wherein:
the controller decreases a duty cycle of the switching transistor when the balance voltage is less than the reference voltage and increases the duty cycle of the switching transistor when the balance voltage is greater than the reference voltage to control an amount of current supplied to the input line.

18. The backlight device of claim 15, further comprising:
a panel unit that includes a thin film transistor panel, a color filter panel, and a liquid crystal layer interposed therebetween,
wherein the backlight device is coupled to one side of the panel unit.
